(19) United States
(12) Patent Application Publication
(10) Pub. No.: US 2005/0256809 A1
(43) Pub. Date: Nov. 17, 2005

(54) Systems and methods for providing notification and feedback based on electronic payment transactions

(76) Inventor: Pasha Sadri, San Jose, CA (US)

Correspondence Address: CROWELL & MORING LLP;INTELLECTUAL PROPERTY GROUP, P.O. BOX 14300, WASHINGTON, DC, 20044-4300, US

(21) Appl. No.: 10/991,539

(22) Filed: Nov. 17, 2004

Related U.S. Application Data
(60) Provisional application No. 60/571,025, filed on May 14, 2004.

(51) Int. Cl. G06F 17/60

(52) U.S. Cl. 705/78

(57) ABSTRACT

Disclosed are systems and methods for providing notifications of financial transactions to the owners of financial accounts. In one embodiment, a user proposes to transact business with a merchant by supplying certain account information to make an electronic payment. A merchant may then submit an authorization request to a clearing house, including details on the proposed transaction. After the clearing house processes the authorization request and verifies funds with the appropriate financial institution, a set of notification parameters may be accessed by the clearing house and used to provide the financial account owner with instant or near instant notification of the transaction. In another embodiment, a feedback request is delivered to the user along with a transaction notification.

### CROSS REFERENCE TO RELATED APPLICATION

This application is related to and claims priority from the U.S. provisional patent application having application No. 60/571,025, filed on May 14, 2004.

### FIELD OF THE INVENTION

The invention relates to systems and methods of providing real-time or near real-time notifications of financial transactions to the owner of a financial account. The invention also relates to a system and method of collecting and managing feedback and ratings information regarding the reported transactions.

### BACKGROUND

Electronic payment methods such as credit or debit cards are increasingly used in commercial transactions. In addition, a growing number of people have access to mobile communications devices such as mobile phones and pagers, or alternatively have access to other forms of electronic communication such as email or instant messaging systems.

With the increase in the usage of electronic payment methods comes an increase in the need for consumers to monitor and track point-of-sale transactions, and other electronic accesses to their financial accounts. Most financial institutions mail out only monthly statements, creating a significant lag between when an electronic payment is made, and when an account owner is notified of the transaction. In the case of a compromised financial account, this amount of time is unacceptable and may lead to significant loses for the account owner and/or financial institution.

Most merchants would like to obtain consumer feedback to further tailor and improve the services and/or good they provide. However, obtaining consumer feedback is often difficult without providing some incentive to the consumer. However, providing sufficient incentives and/or methods for consumers to provide feedback can be costly. Thus, there is a need in the industry for a system and method for providing effective and meaningful notification and feedback of such transactions.

### BRIEF SUMMARY OF THE INVENTION

Systems and methods for providing notification and feedback based on electronic payment transactions are disclosed. In one embodiment, a method includes receiving an authorization request from a merchant for a financial account of a user, where the financial account is maintained by a financial institution and the authorization request relates to a proposed transaction between the user and the merchant. The method further includes exchanging financial information with the financial institution in order to respond to the authorization request, responding to the authorization request based on the exchanged financial information, and retrieving notification parameters for the user. In one embodiment, the method further includes providing a transaction notification to the user according to the notification parameters, where the transaction notification includes transaction details for a completed transaction with the merchant.

Other embodiments are disclosed and claimed herein.

### BRIEF DESCRIPTION OF DRAWINGS

FIG. 1 is a diagram illustrating one embodiment of a system and method that implements the principles of the invention;

FIG. 2 is a diagram illustrating an alternate embodiment of the system and method that implements the principles of the invention; and

FIG. 3 is a diagram illustrating a third embodiment of the notification system and method that implements the principles of the invention.

### DETAILED DESCRIPTION OF EXEMPLARY EMBODIMENTS

One aspect of the invention relates to a system and method of providing real-time or near real-time notifications of financial transactions to the owner(s) of a financial account(s), such as a bank account. In one embodiment, a user proposes to transact business with a merchant by supplying certain account information to make an electronic payment. The payment may be in the form of a debit transaction, a credit transaction, etc. Using the supplied account information, the merchant may then submit an authorization request to a clearing house. In one embodiment, the authorization request is a request to make an electronic payment from the financial account in question. This authorization request will typically include details on the proposed transaction, such as the amount of the purchase. In one embodiment, the merchant using a point-of-sale terminal to access a server of the clearing house using a network connection.

Another aspect of the invention is to enable the clearing house to process the authorization request, and to access the consumer's financial account in question. Once the proper financial account is located, the clearing house and the financial institution maintaining the account may exchange information to determine if the authorization request should be granted. Once the clearing house has determined that the authorization request should be granted, a set of notification parameters may be accessed by the clearing house and used to provide the financial account owner with instant or near instant notification of the transaction.

Yet another aspect of the invention relates to providing a financial account owner with a portal through which they can monitor and review account details and transactions. In one embodiment, the portal is a webpage through which an account owner can review transaction details, such as the transaction date and amount, as well as merchant details. In this fashion, a financial account owner may actively monitor and review their accounts in addition to receiving automatic notifications as detailed herein.

Still another aspect of the invention relates to a system and method of organizing, collecting and managing feedback and ratings regarding the reported transactions. In one embodiment, a feedback request is delivered to the user along with a transaction notification. Various embodiments are described herein.

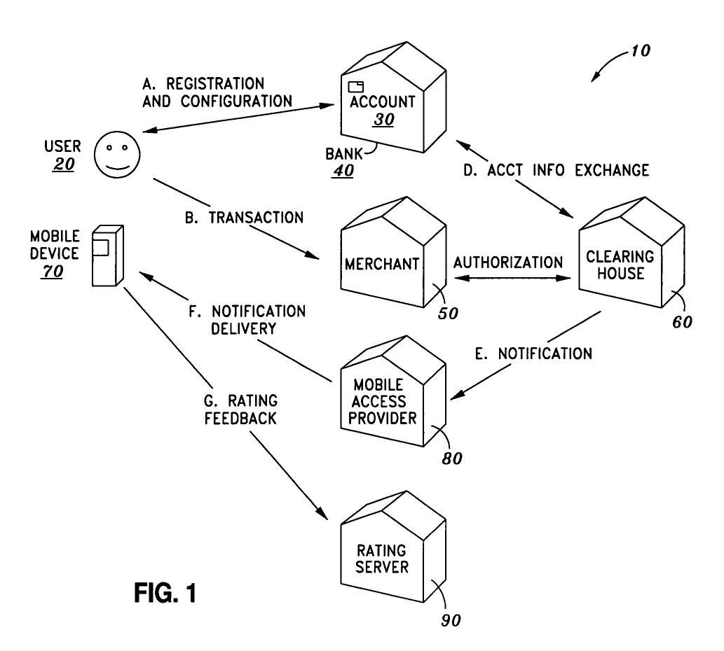

FIG. 1 illustrates one embodiment of a system 10 and method that implements the principles of the invention. In this embodiment, a user 20 registers an account 30 at a financial institution 40, such as a bank, as shown in FIG. 1. It should be appreciated that the user may sign up for the account 30 in person at the financial institution 40, online using a Internet connection to the financial institution 40, or any other known means for setting up a financial account.

Once the account 30 is established, the user 10 may participate in commercial transaction using an electronic payment network (EPN) (not shown). For example, the user 10 may propose a transaction with a merchant 50 by visiting the merchant's 50 store, placing an order online, etc. The merchant 50 is typically equipped with an interface to the EPN in the form of a credit/debit card point-of-sale terminal (POS). However, it should be appreciated that the merchant may have access to the EPN network using other access methods. In one embodiment, before the merchant can collect the amount due on the proposed transaction, the transaction has to be cleared by a transaction clearing house 60. In such an embodiment, the merchant's POS may be connected to the clearing house 60 via the EPN. The clearing house 60 may exchange information about the user's account 30 with the appropriate financial institution 40 through a communication network (not shown), or any other communications link. The user 20 may also receive electronic messages via the communication network (e.g., the Internet). The clearing house 60 and the financial institution 40 (such as a bank) may also be connected to the Internet and can therefore send messages to the user 20.

In addition to setting up the account 30, the user 20 may also register and configure methods of electronic communication (or notification methods) such as email, SMS message, page or instant message for receiving notifications of transactions on their account 30 at the bank 40 (see step A in FIG. 1). In addition to registering for automatic notifications, the user 20 may similarly register to access their account 30 and/or transaction details through a remote portal, such as a webpage or similar interface. In this fashion, the user 20 may passively monitor their account 30 and related transactions. Whether registering for automatic notification or passive monitoring, this registration process can occur at the time of opening the account 30 (performed on-line, by phone or in person) or later, via any technique or system such as via the Internet or phone. In addition to specifying a method of communications, the account configuration can also allow the user 20 to specify the circumstances under which they wish to be notified. For example, the user 20 can request that they only be notified for transactions over $100 in amount, or that they are not notified about transactions at certain merchants such as specific stores, etc. The factors that may be involved at this step may be user defined, defined by the system developer or defined by any other means. These factors may include but are not limited to:
the merchant identity. e.g. don't send a notification if transaction involved specific merchants;
the transaction amount. e.g. only send notification if amount is more than $100;
the transaction frequency. e.g. don't send a notification if this transaction recurs monthly;
the nature of the merchant. e.g. don't send notifications from grocery stores and gas stations; and
the time of the transactions. e.g. only send notifications during weekdays.

After a transaction has been processed by the clearing house 60, the system running at the clearing house 60 may retrieve the details of the notification method associated with the user's account 30 (step D in FIG. 1) and if applicable, send an electronic notification message (or, “notification”) to the user 20 using the specified technique (step E in FIG. 1). The contents of the notification may also depend on the configuration of the user's account 30. Some examples may include, but are not limited to the following:
simple notification of transaction: “Your ABC Bank debit account ending with 6543 was just charged for $45.50 by ACME, Palo Alto, Calif.”
notification of transaction and feedback request: “Your US Bank credit account ending with 9876 was just charged for $90.00 by Pasta Maker Palo Alto, Calif. Would you like to rate your experience? [1 2 3 4 5] [skip]”.

The notification is delivered to the user 20 (step F in FIG. 1) via any communications mode, technique, infrastructure or system. In one embodiment, and as shown in FIG. 1, the communication mode involves delivery to a mobile device 70, which may be performed through a mobile access provider or wireless telephone service company 80.

The notification delivery (step F in FIG. 1) may also include a feedback request, which may be sent under certain circumstances where it is appropriate to collect rating feedback for the merchant. One example of such a circumstance is when the merchant is a service-oriented entity such as restaurant or car mechanic.

In the case of feedback requests, the notification message may include a way for the user 20 to provide feedback rating information about his/her experience or transaction with the merchant, regardless of the method in which the user 20 was notified. For example, if the user 20 received a SMS message, the user 20 may send a reply to that SMS message in the form of a number between 1 to 5 to indicate the rating score of the merchant. Alternatively, if the notification is sent in the form of an email, the email may contain HTML code that would render a feedback user interface (UI), as is known in the technology, on the user's email client. The user 20 may then select their feedback rating and press a button to submit the information to the rating server. In one embodiment, the way that a user 20 may submit his/her feedback may be tailored to the capabilities of the device and method of the notification delivery. The user's feedback will be transmitted via the Internet to a rating server 90 for collection and management (step G in FIG. 1) of the information. The information sent to the rating server 90 may include the identity of the user 20, the amount of the transaction, the merchant 50 and the users' rating for the goods or service they received.

The rating server 90 is responsible for recording the user feedback information and managing a real-time rating associated with each merchant 50 (or “merchant rating”). It should be appreciated that the merchant rating can be calculated in different ways which can involve many factors. Some of the factors involved include but are not limited to:
the rating history of the merchant 50. for example, if one has not recently received rating information about a merchant, the overall merchant rating can be reduced to reflect the lack of user activity at that merchant;
the rating history of the user 20. for example, if a user 20 consistently rates every merchant 50 with a certain bias, that bias could be taken into the account; and
the amount of the transaction. for example, ratings associated with higher payment amounts can be weighted more than those associated with smaller amounts

In one embodiment, the rating server 90 is able to generate a report of merchant ratings for external consumption. For example, may be able to query the rating server to retrieve the current or historical rating for a merchant to help them decide whether they wish to transact with that merchant. Additionally, the merchants may choose to view the ratings submitted regarding their services and/or goods.

In summary, FIG. 1 illustrates one implementation of the invention where the customer is able to register and configure his/her notification service at any point via the Internet or other means provided by the financial institution. In addition, the customer may receive transaction notification messages on their mobile communication device as soon as a transaction takes place on their account. This notification may tell the customer the time, amount, merchant and location of the transaction. If applicable, the notification may also include a way of allowing the customer to provide immediate feedback about the service they just received.

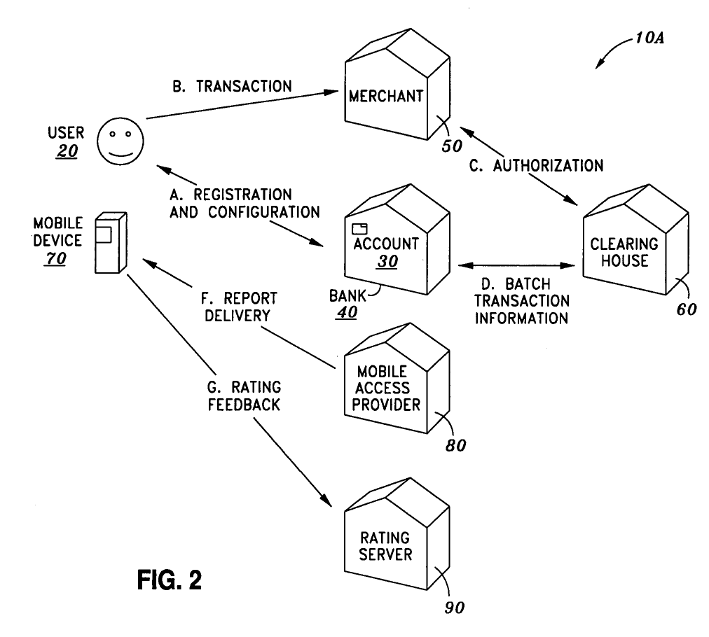

Due technical limitations at the clearing house, it may not be possible to send transaction notifications in real-time. To that end, FIG. 2 illustrates an alternate embodiment of the system and method shown in FIG. 1. In this case, an alternative implementation of this invention may process a record of transactions in batch mode on a recurring basis (for example, every 24 hours). The customer may then receive a report of their transactions during the past 24 hours with a chance to provide feedback on the applicable ones. This scenario is depicted in FIG. 2. In general, the system and method 10A of FIG. 2 may involves the user 20 registering and configuring an account 30 with bank 40 (step A). Thereafter, upon making a purchase choice, the user 20 may propose a transaction with a merchant 50 by supplying the merchant with specific account information, such as a debit account number or a credit account number (Step B). Such information will typically be supplied by presenting a debit/credit card to the merchant, but similarly may be made in other ways (e.g., over the phone, online, etc.).

At this point the merchant will transmit the payment information to clearing house 60 for authorization (Step C). This may be done, for example, via the previously-described EPN. At the end of the day (or some other period of time), the clearing house 60 may send a batch report of the user's 20 transactions to the bank 40 (Step D). The bank 40 may then send a transaction report to the user 20 of FIG. 2 according to their previously-provided notification method (Step E). The transaction report may then be delivered to the user's mobile device 70 via their mobile access provider 80 (Step F). As with the embodiment of FIG. 1, the user may provide optional feedback by transmitting from their mobile device 70 to the rating server 90 (Step G).

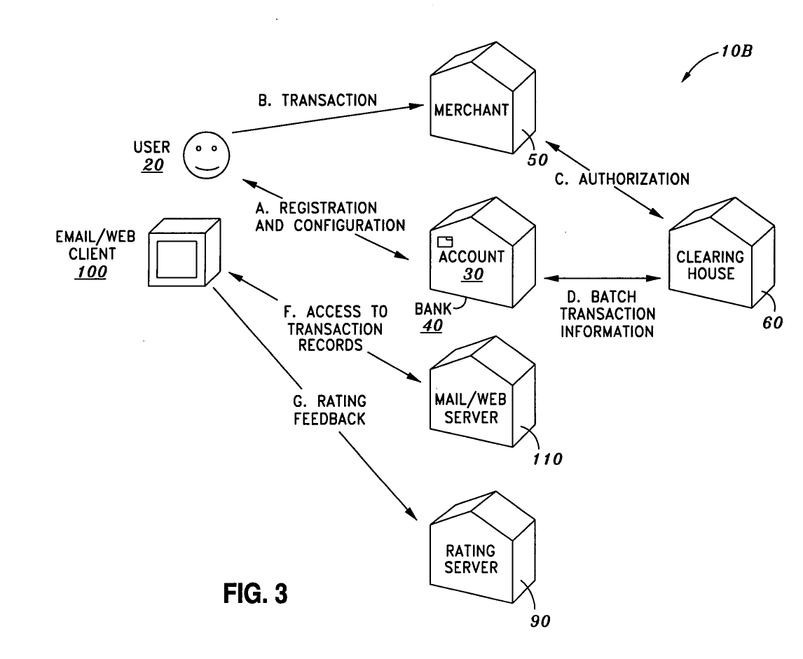

Referring now to FIG. 3, if the user 20 does not have access to a mobile device 60 that they can carry at all times, they may alternatively be able to receive transaction notifications via other modes, such as email or a web-based interface. This scenario is depicted in FIG. 3. The system and method 10B shown in FIG. 3 again involves the user 20 registering and configuring an account 30 with bank 40 (step A). Thereafter, upon making a purchase choice, the user 20 may propose a transaction with a merchant 50 by supplying the merchant with specific account information, such as a debit account number or a credit account number (Step B). At this point, the merchant may transmit the payment information to clearing house 60 for authorization (Step C). This may be done, for example, via the previously-described EPN. At the end of the day (or some other period of time), the clearing house 60 may send a batch report of the user's 20 transactions to the bank 40 (Step D). The bank 40 may then send a transaction report to the user 20 of FIG. 3 according to their previously-provided notification method (Step E). In this case, the transaction report is shown in FIG. 3 as being sent vial mail/web server 110. Specifically, the transaction report may be sent via email, posted to a web-based application and/or accessed by a web-based application on demand. In such a case, the user 20 is able to access and passively monitor their account 30 using an email/web 100 (Step F). In addition to accessing the transaction report, the user 20 may also use mail/web server 110 to review recent transactions. In one embodiment, user 20 may access mail/web server 110 via a network (e.g., the Internet) using email/web client 100, or any other computer system capable of accessing the mail/web server 110. As with the embodiments of FIGS. 1 and 2, the user may provide optional feedback by transmitting from their email/web client 100 to the rating server 90 (Step G).

While the preceding description has been directed to particular embodiments, it is understood that those skilled in the art may conceive modifications and/or variations to the specific embodiments described herein. Any such modifications or variations which fall within the purview of this description are intended to be included herein as well. It is understood that the description herein is intended to be illustrative only and is not intended to limit the scope of the invention.

1. A method comprising:
receiving an authorization request from a merchant for a financial account of a user, where said financial account is maintained by a financial institution and said authorization request relates to a proposed transaction between the user and the merchant;
exchanging financial information with the financial institution to respond to said authorization request;
responding to said authorization request by said merchant based on said exchanging financial information;
retrieving notification parameters for said user; and
providing a transaction notification to said user according to said notification parameters, where the transaction notification includes transaction details for a completed transaction with said merchant.

2. The method of claim 1, wherein receiving comprises receiving a request from the merchant for an electronic payment funds from the financial account of the user.

3. The method of claim 2, wherein receiving comprises receiving the request from said merchant for said electronic payment, where said financial account is a bank account and said financial institution is a bank.

4. The method of claim 1, wherein said exchanging comprises exchanging information with the financial institution relating to said financial account and to the proposed transaction.

5. The method of claim 1, wherein said responding comprises authorizing said proposed transaction when said financial account contains sufficient funds for said proposed transaction, and wherein said responding further comprises denying said proposed transaction when said financial account contains insufficient funds for said proposed transaction.

6. The method of claim 1, wherein retrieving comprises retrieving notification parameters that were previously provided by said user and associated with the financial account.

7. The method of claim 1, wherein providing a transaction notification comprises providing a transaction notification to said user according to said notification parameters, where the transaction notification includes at least one of a time, an amount, a merchant name and a location of the completed transaction.

8. The method of claim 1, wherein said receiving the authorization request, said exchanging financial information, said responding to the authorization request, said retrieving notification parameters, and said providing the transaction notification all occur over wireless communication links.

9. The method of claim 1, wherein providing a transaction notification comprises providing the transaction notification to said user according to said notification parameters using at least one of email, SMS messaging, paging and instant messaging.

10. The method of claim 1, wherein said retrieving comprises retrieving notification parameters for said user, where said notification parameters include information for filtering which transactions the user will be notified of.

11. The method of claim 1, wherein said providing a transaction notification comprises providing a transaction notification to said user according to said notification parameters, where the transaction notification includes transaction details for the completed transaction with said merchant, and further includes a feedback request relating to said merchant.

12. The method of claim 11, further comprising receiving feedback over a wireless communications link from said user relating to the completed transaction with said merchant, said feedback to be provided in response to said feedback request.

13. The method of claim 1, wherein said providing the transaction notification comprises providing a batch transaction notification to said user according to said notification parameters, where the batch transaction notification includes transaction details for a plurality of transactions with a plurality of merchants.

14. The method of claim 1, wherein said providing the transaction notification comprises updating a remote server with said transaction details, and wherein the method further comprises accessing said remote server over a network, and reviewing a plurality of recent transactions associated with said financial account, including said completed transaction.

15. A system comprising:
a network;
a merchant terminal coupled to the network;
a first server, coupled to the network, to maintain a user's financial account, wherein said second server is associated with a financial institution; and,
a second server coupled to the network to,
receive and process an authorization request from said merchant terminal to access said financial account, wherein said authorization request relates to a proposed transaction with said merchant,
exchange financial information with said first server to respond to said authorization request,
respond to said authorization request based on said financial information exchanged with the first server,
retrieve notification parameters for said user from said first server, and
provide a transaction notification to said user according to said notification parameters, where the transaction notification includes transaction details for a completed transaction with said merchant.

16. The system of claim 15, wherein said authorization request is a request by said merchant to receive an electronic payment from the financial account of the user.

17. The system of claim 16, wherein said financial account is a bank account and said financial institution is a bank.

18. The system of claim 15, wherein said financial information includes information relating to said financial account and to the proposed transaction.

19. The system of claim 15, wherein the second server responds to the authorization request by authorizing the proposed transaction when said financial account contains sufficient funds for said proposed transaction, and wherein the second server further responds to the authorization request by denying the proposed transaction when said financial account contains insufficient funds for said proposed transaction.

20. The system of claim 15, wherein said notification parameters are provided by said user and are associated with the financial account.

21. The system of claim 15, wherein the transaction notification includes at least one of a time, an amount, a merchant name and a location of the proposed transition.

22. The system of claim 15, wherein said network is an electronic payment network.

23. The system of claim 15, wherein the transaction notification is provided by said second server using at least one of email, SMS messaging, paging and instant messaging.

24. The system of claim 15, wherein said notification parameters include information for filtering which transactions the user will be notified of.

25. The system of claim 15, wherein said transaction notification includes transaction details for a transaction with said merchant, and further includes a feedback request relating to said merchant.

26. The system of claim 25, wherein said second server is further to receive feedback from said user relating to the proposed transaction with said merchant, said feedback to be provided in response to said feedback request.

27. The system of claim 15, wherein said second server, in order to provide the transaction notification, provides a batch transaction notification to said user according to said notification parameters, where the batch transaction notification includes transaction details for a plurality of transactions with a plurality of merchants.

28. The system of claim 15, wherein said second server, in order to provide the transaction notification, updates a user account with said transaction details, and wherein the second server is to be configured to allow said user to access said user account over said network to review a plurality of recent transactions associated with said financial account, including said completed transaction.

29. A method for providing a transaction notification comprising:
receiving an authorization request from a merchant relating to a proposed transaction between a user and said merchant, wherein said authorization request is a request for funds from a financial account of said user, where said financial account is maintained by a financial institution;
verifying with the financial institution that said financial account contains sufficient funds for the proposed transaction;
authorizing said proposed transaction when said financial account contains sufficient funds for said proposed transaction;
retrieving notification parameters for said user; and,
providing said transaction notification to said user according to said notification parameters, where the transaction notification includes transaction details for a completed transaction with said merchant.

30. The method of claim 29, wherein retrieving comprises retrieving notification parameters that were previously provided by said user and associated with the financial account.

31. The method of claim 29, wherein providing a transaction notification comprises providing a transaction notification to said user according to said notification parameters, where the transaction notification includes at least one of a time, an amount, a merchant name and a location of the completed transaction.

32. The method of claim 29, wherein receiving the authorization request, verifying with the financial institution, authorizing said proposed transaction, retrieving notification parameters, and providing the transaction notification all occur over wireless communication links.

33. The method of claim 29, wherein providing a transaction notification comprises providing the transaction notification to said user according to said notification parameters using at least one of email, SMS messaging, paging and instant messaging.

34. The method of claim 29, wherein said retrieving comprises retrieving notification parameters for said user, where said notification parameters include information for filtering which transactions the user will be notified of.

35. The method of claim 29, wherein said providing a transaction notification comprises providing a transaction notification to said user according to said notification parameters, where the transaction notification includes transaction details for the completed transaction with said merchant, and further includes a feedback request relating to said merchant.

36. The method of claim 35, further comprising receiving feedback from said user relating to the completed transaction with said merchant, said feedback to be provided in response to said feedback request.

37. The method of claim 29, wherein said providing the transaction notification comprises providing a batch transaction notification to said user according to said notification parameters, where the batch transaction notification includes transaction details for a plurality of transactions with a plurality of merchants.

38. The method of claim 29, wherein said providing the transaction notification comprises updating a remote server with said transaction details, and wherein the method further comprises providing access to said remote server over a network, and enabling said user to review a plurality of recent transactions associated with said financial account, including said completed transaction.
